(19) United States
(12) Patent Application Publication
(10) Pub. No.: US 2020/0147437 A1
(43) Pub. Date: May 14, 2020

(54) SYSTEM FOR GENERATING A FORCE, IN PARTICULAR A DRIVING FORCE

(71) Applicant: GIROTTO BREVETTI S.R.L., Spresiano (IT)

(72) Inventor: Adriano GIROTTO, Spresiano (IT)

(21) Appl. No.: 16/614,331

(22) PCT Filed: May 17, 2018
(86) PCT No.: PCT/IT2018/050086

§ 371 Date: Nov. 15, 2019

(30) Foreign Application Priority Data
May 18, 2017 (IT) 102017000054029

(51) Int. Cl. A63B 21/00; A63B 21/22; F16H 1/16

(52) U.S. Cl. CPC A63B 21/00192; A63B 21/15; H01F 7/02; F16H 1/16; A63B 2209/08; A63B 21/22

(57) ABSTRACT

The present invention relates to a system for generating a force, in particular a driving force comprising: a first unit comprising a first tubular element, first magnetic means, a second unit comprising a second tubular element, where said second tubular element is coaxial with said first tubular element, second magnetic means, third magnetic means. Said first magnetic means are arranged within said first tubular element, and said second magnetic means and said third magnetic means are arranged on said second tubular element so as to be opposed to each other. Said first tubular element is arranged within said second tubular element and is configured to rotate of a predetermined rotation angle in such a way that, when said first tubular element rotates, said first magnetic means rotates with respect to said second magnetic means and said third magnetic means, so that a predetermined first force is generated by said system.

The present invention relates to a system for generating a force, in particular a driving force.

Particularly, the invention relates to the structure of a system of said type, connectable to a fitness machine, configured to generate a force, in particular a driving force, by means of a magnetic or pneumatic mechanism.

More particularly, with reference to a fitness machine, said system is able to substitute the device for generating a force, constituted by a pack of weights, that is connected to an actuator of the fitness machine itself, such as a handlebar, on which a user acts to perform a physical activity.

In general, the weight of said pack of weights is transferred, by at least one string and at least one pulley, to the handlebar of the fitness machine, and the force generated by said pack of weights must be won by said user during the physical activity.

Currently, several devices are known for generating a force, which can be applied to fitness machines.

With reference to a fitness machine disclosed in the U.S. Pat. No. 8,360,935, said device for generating a force can comprise weights, springs or electric motors.

A disadvantage of said device is given by the fact that weights or springs are bulky and expensive elements.

The same applies to electric motors that also require electronic controls.

With reference to a fitness machine disclosed respectively in the U.S. Pat. Nos. 6,857,993 and 6,599,223, the device for generating a force of each of said fitness machines comprises a plurality of metal flywheels which interact with a permanent magnet. In other words, said device can be considered a magnetic clutch that exploits the generation of parasitic currents in the flywheel and the interaction with said parasitic currents.

A first disadvantage is given by the fact that said flywheels limit the fitness machines which require rotating parts.

A second disadvantage of said device is given by the fact that said flywheels are bulky and heavy elements.

A third disadvantage is given by the fact that a force is generated only when a flywheel rotates.

A further disadvantage is given by the fact that, for safety reasons, a brake is required for said flywheels.

A further device for generating a force is disclosed in the Italian patent application N. 102015000052403.

Said device comprises a first structure consisting of first elements comprising magnetic material and arranged at a predetermined first distance from each other in such a way that a plurality of first spaces are present between two first elements arranged in succession, and a second structure consisting of seconds elements comprising reactive material to the magnetic field and arranged at a predetermined second distance from each other in such a way that a plurality of second spaces are present between two second elements arranged in succession, wherein each structure is movable with respect to a reference direction in such a way that said first elements occupy said second spaces and said second elements occupy said first spaces.

However, a disadvantage of said device of known type is given by the fact said device is bulky and expensive.

Object of the present invention is overcome said disadvantages, providing a system for generating a force, in particular a driving force, where said system is connectable to a fitness machine and has a simple and low cost structure.

Advantageously, when said system is connected to a fitness machine, it can replace the pack of weights of such a fitness machine, so that, when said fitness machine is in use, the force generated by said system simulates the resistance exerted by the pack of weights during a exercise performed by a user.

It is therefore object of the invention a system for gene rating a force, un particular a driving force, where said system is connectable to a fitness machine and comprises:
a first unit comprising:
   a first tubular element having a longitudinal axis,
   first magnetic means comprising at least one first magnetic element,
a second unit comprising:
   a second tubular element, where said second tubular element is coaxial with said first tubular element,
   second magnetic means comprising at least one second magnetic element,
   third magnetic means comprising at least one third magnetic element,

where

said at least one first magnetic element is arranged within said first tubular element,

said at least one second magnetic element and said at least one third magnetic element are arranged on said second tubular element so as to be opposed to each other,

said first tubular element is arranged within said second tubular element and is configured to rotate about its longitudinal axis of a predetermined rotation angle in a first direction or in a second direction, opposite to said first direction, in such a way that, when said first tubular element rotates, said at least one first magnetic element rotates with respect to said at least one second magnetic element and said at least one third magnetic element, so that a predetermined first force is generated by said system, the value of said predetermined first force depending on the masses of said at least one first magnetic element, of said at least one second magnetic element and of said at least one third magnetic element, on the polarity of said at least one first magnetic element with respect to the polarity of said at least one second magnet and said at least one third magnetic element and on said predetermined angle of rotation.

In particular, said second tubular element comprises an inner surface and an outer surface, and said at least one second magnetic element can be arranged on a portion of the outer surface of said second tubular element, and said at least one third magnetic element can be arranged on a further portion of the outer surface of said second tubular element, opposite to said portion.

Furthermore, said first tubular element comprises an inner surface and an outer surface, and said system can comprise a casing having a cavity which comprises a surface, and said first unit and said second unit can be arranged within the cavity of said casing, where said second unit can be slidably coupled to said first unit so as to slide with respect to said first unit, within said casing, from a first position, in which said second unit is overlapped on said first unit, to a second position, in which said second unit is translated by a predetermined first distance with respect to said first unit and partially overlapped on said first unit, so that a space between the outer surface of the first tubular element and the surface of the cavity of said casing is created, and vice versa. In said first position, the resulting force generated by said system is said predetermined first force and in said second position, a predetermined second force is generated by said system, the value of which depends on the dimensions of the cross-section of said cavity of said casing and on said predetermined first distance, and the resulting force generated by said system is the sum of said predetermined first force and said predetermined second force.

With particular reference to said at least one first magnetic element, said at least one first magnetic element can comprise a first face and a second face, opposite to said first face, each of which has a respective first portion polarized with a first polarity and a second portion polarized with a second polarity, opposite to said first polarity, a third face, where said third face connects the first portion of said first face to the first portion of the second face and is polarized with said first polarity, and a fourth face, opposite to said third face, where said fourth face connects the second portion of said first face to the second portion of the second face and is polarized with said second polarity.

Furthermore, said at least one first magnetic element can be arranged within said first tubular element in such a way that a first axis, coincident with said longitudinal axis, is perpendicular to said first face and said second face, and that said third face and said fourth face contact said inner surface of said first tubular element.

With particular reference to said at least one second magnetic element, said at least one second magnetic element can comprise a first face and a second face, opposite to said first face, each of which has a respective first portion polarized with a first polarity and a respective second portion polarized with a second polarity, opposite to said first polarity, a third face, arranged between said first face and said second face and polarized with said second polarity.

Furthermore, said at least one second magnetic element can be arranged on said second tubular element in such a way that said third face contacts a portion of said outer surface of said second tubular element.

With particular reference to said at least one third magnetic element, said at least one third magnetic element can comprise a first face and a second face, opposite to said first face, each of which has a respective first portion polarized with a first polarity, and a second portion polarized with a second polarity, opposite to said first polarity, a third face, arranged between said first face and said second face and polarized with said first polarity.

Furthermore, said at least one third magnetic element can be arranged on said second tubular element in such a way that said third face contacts a further portion of said outer surface of said second tubular element, opposite to said portion.

According to the invention, said first magnetic means can comprise a first plurality of first magnetic elements, said first magnetic elements can be in contact with each other and arranged in succession within said first tubular element along said first axis so that the second face of a first magnetic element is in contact with the first face of the first magnetic element arranged in succession.

Furthermore, said second magnetic means can comprise a second plurality of second magnetic elements, where said second magnetic elements can be arranged in succession along said portion of said outer surface of said second tubular element so that the second face of a second magnetic element contacts the first face of the second magnetic element arranged in succession and that the third face of each second magnetic element contacts said outer surface of said second tubular element, and said third magnetic means can comprise a third plurality of third magnetic elements, where said third magnetic elements can be arranged in succession along said further portion of said outer surface of said second tubular element, so that the second face of each third magnetic element contacts the first face of the third magnetic element arranged in succession and that the third face of each third magnetic element contacts said outer surface of said second element tubular.

It is preferable that said second unit comprises coupling means made of ferromagnetic material for coupling said second magnetic means and said third magnetic elements with said outer surface of said second tubular element and blocking means for blocking said coupling means.

In particular, said coupling means can comprise a plurality of sheets arranged in succession in such a way that said sheets are overlapped on said second magnetic elements and said third magnetic elements, where each sheet has a first hole shaped to allow the passage of said second tubular element, said second magnetic means and said third magnetic means, as well as a second hole and a third hole, and said blocking means can comprise a first blocking element and a second blocking element, where said first blocking element and said second blocking element pass through respectively said second hole and said third hole.

Advantageously, said system can comprise rotating means for rotating said first tubular element with respect to said second tubular element of said predetermined rotation angle.

It is preferable that said rotation means comprise a worm screw, a gear wheel, geared with said worm screw in such a way that, when said worm screw rotates, said gear wheel rotates, and a shaft, coupled to said geared wheel and said first tubular element in such a way that, when said gear wheel rotates, said shaft rotates causing the rotation of said first element tubular.

Furthermore, said system can comprise a container, arranged at a first end of said first tubular element, and said container can have an inlet for the passage of an amount of air from the external environment inside the casing and can comprise opening/closing means for opening/closing said inlet in order to allow/prevent the passage of said amount of air inside said casing through said inlet.

With reference to said rotating means and said container, at least one portion of said worm screw, said gear wheel and said shaft can be arranged inside said container and said container can have a hole to allow the passage of a first end portion of said first tubular element in such a way that said first end portion is connected to said shaft. A first sealing gasket can be arranged between said hole and said first end portion of said first tubular element.

Furthermore, said system can comprise a cap, arranged at a second end of said first tubular element, opposite to said first end, where said cap can be provided with first sliding means for facilitating the sliding of said second unit on said first unit.

According to the invention, said first unit can comprise positioning means for positioning said at least one first magnetic element within said first tubular element along said first axis, where said positioning means can be arranged within said first tubular element.

In particular, said positioning means can comprise at least one first positioning element, arranged in contact with a fifth face of said at least one first magnetic element and with said inner surface of said first tubular element, and at least one second positioning element, arranged in contact with a sixth face of said at least one first magnetic element, opposite to said fifth face, and with said inner surface of said first tubular element.

Furthermore, said second unit can comprise:
a first head, arranged at a first end of said second tubular element, where said first head comprises inside a piston having the cross-section in the shape of a circular crown, where said piston is integral with said first head, a second sealing gasket and a third sealing gasket respectively in contact with the inner circumference and the outer circumference of said circular crown, and
a second head, arranged at a second end of said second tubular element, opposite to said first end.

Said first head and said second head can be provided respectively with second sliding means and third sliding means for facilitating the sliding of said second unit on said first unit.

According to the invention, said cavity of said casing can be provided with at least one first projection, and said second unit can comprises guiding means to allow said second unit to slide with respect to said casing on said first projection, where said guiding means can comprise at least one first guiding element.

In particular, said cavity can be provided with a second projection, where said first projection and said second projection are arranged on the surface of said cavity respectively at a first surface portion and a second surface portion, opposite to said first surface portion, and said guiding means can comprise a second guiding element, where said first guiding element and said second guiding element slide respectively on said first projection and on said second projection.

Furthermore, said system can comprise a third unit arranged within said cavity of said casing and said third unit can be slidably coupled to said second unit in such a way to slide with respect to said first unit, within said casing, from a first position, in which said third unit is overlapped on said second unit, to a second position, in which said third unit is translated by a predetermined second distance with respect to said second unit and is partially overlapped on said second unit, and vice versa.

The present invention will be now described, for illustrative, but not limitative purposes, according to its embodiment, making particular reference to the enclosed figures, wherein:

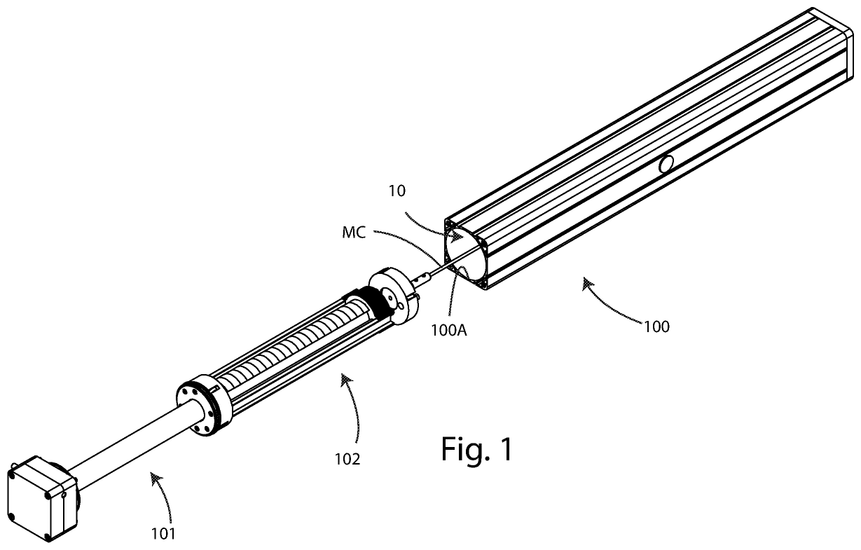

FIG. 1 shows a first embodiment of the system for generating a force, in particular a driving force, according to the invention, where said system comprises a casing inside which a first unit and a second unit, sliding with respect to said first unit, are arranged;

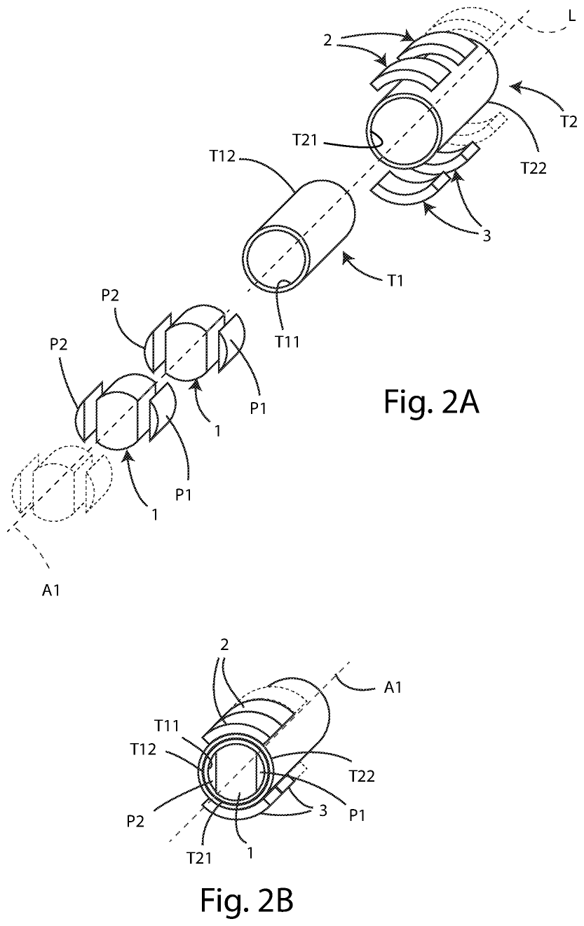

FIG. 2A is an exploded view of a part of the system of FIG. 1, showing a first tubular element, a first plurality of first magnetic elements arranged in succession, a second tubular element, a second plurality of second magnetic elements arranged in succession and a third plurality of third magnetic elements arranged in succession;

FIG. 2B is a view of a part of the system of FIG. 1 showing the first plurality of first magnetic elements arranged inside the first tubular element, as well as the second plurality of second magnetic elements and the third plurality of third magnetic elements arranged on portions opposite of the outer surface of the second tubular element;

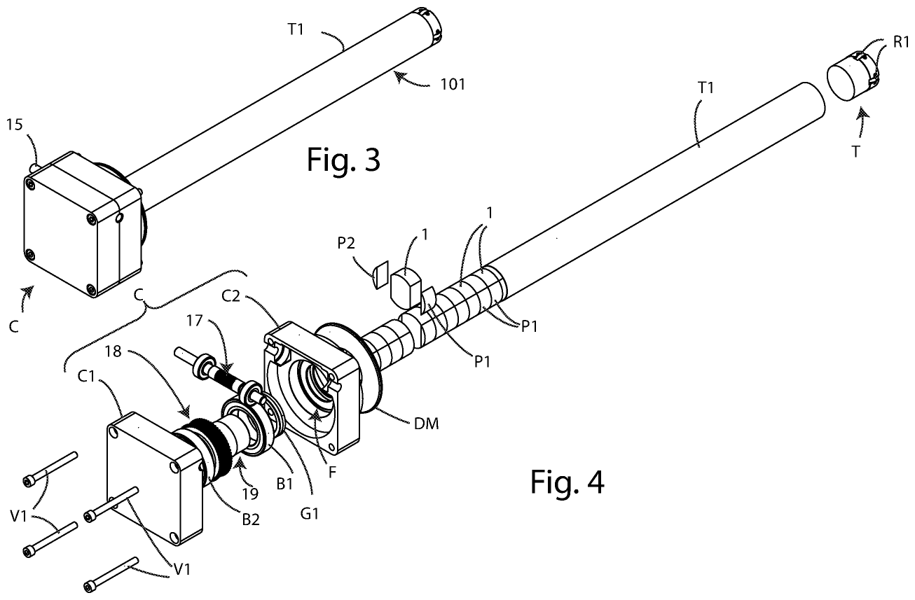

FIG. 3 shows the first unit of the system of FIG. 1;

FIG. 4 is an exploited view of the first unit shown in FIG. 3;

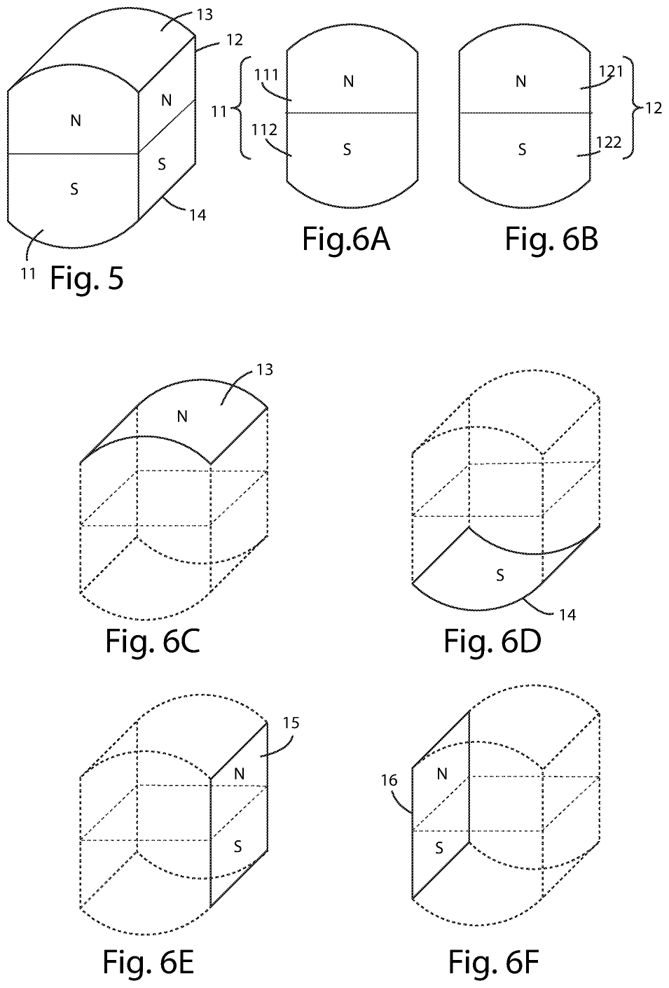

FIG. 5 shows a first magnetic element of said first unit;

FIGS. 6A, 6B, 6C, 6D, 6E, 6F show respectively the first face, the second face, the third face, the fourth face, the fifth face and the sixth face of the first magnetic element shown in FIG. 5;

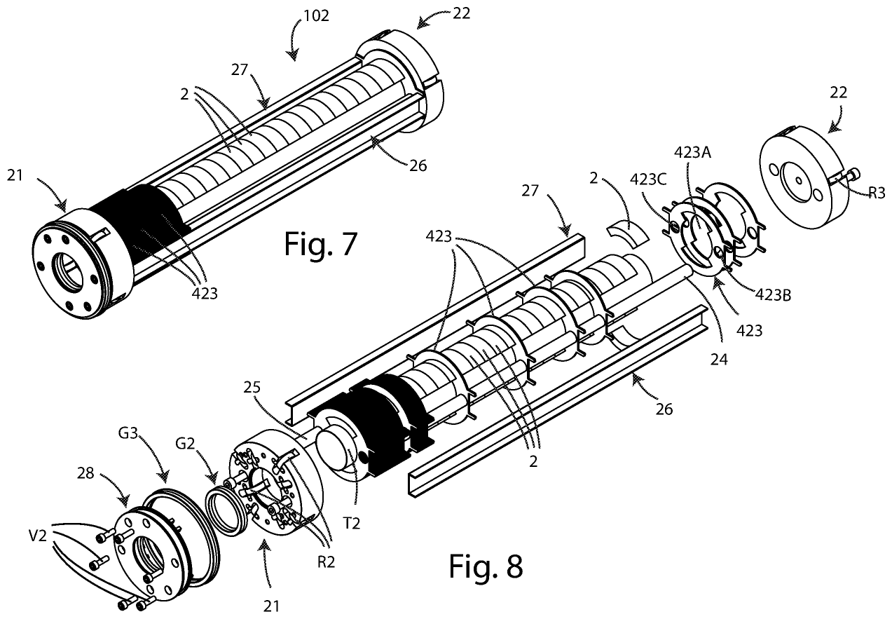

FIG. 7 shows the second unit of the system of FIG. 1;

FIG. 8 is an exploited view of the second unit shown in FIG. 7;

FIG. 9 shows a second magnetic element of said second unit;

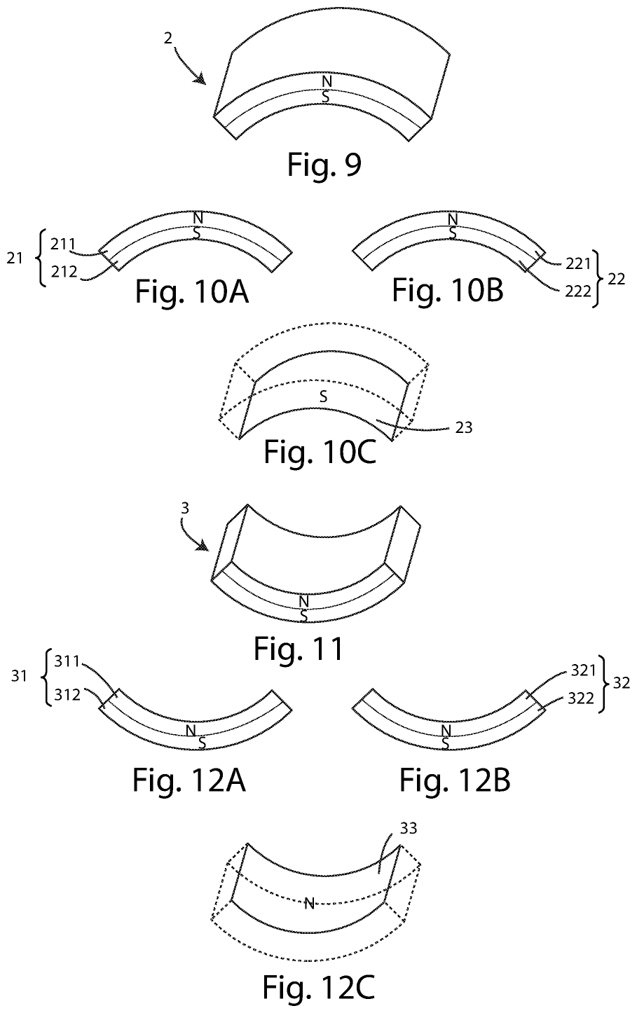

FIGS. 10A, 10B, 10C show respectively the first face, the second face and the third face of the second magnetic element shown in FIG. 9;

FIG. 11 shows a third magnetic element of said second unit;

FIGS. 12A, 12B, 12C show respectively the first face, the second face and the third face of the third magnetic element shown in FIG. 11;

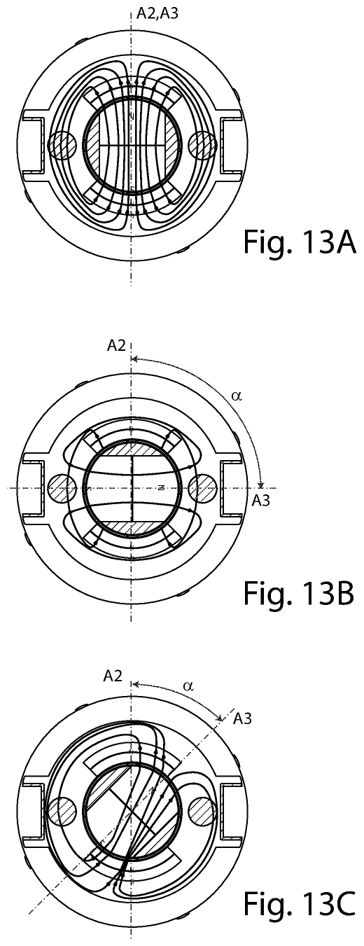

FIGS. 13A, 13B, 13C show a respective schematic view of the magnetic flows generated by the first magnetic elements, the second magnetic elements and the third magnetic elements of the system of FIG. 2A, when the first tubular element of the first unit is in a respective position with respect to the second tubular element of the second unit;

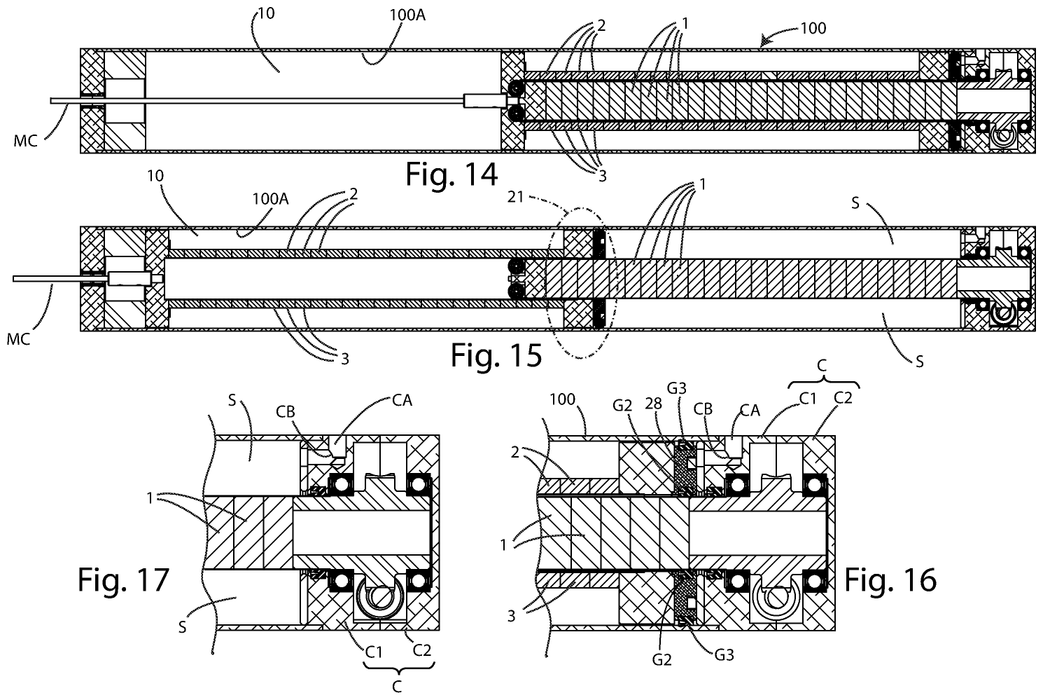

FIG. 14 shows the situation in which the first unit and the second unit are arranged inside the casing and the second unit is overlapped on the first unit;

FIG. 15 shows the situation in which the first unit and the second unit are arranged inside the casing and the second unit is translated with respect to the first unit so as to be partially overlapped on the first unit;

FIG. 16 is an enlargement of a portion of the system of FIG. 14, when the second unit is overlapped on the first unit;

FIG. 17 is an enlargement of the portion shown in FIG. 15, when the second unit is translated inside the casing with respect to the first unit;

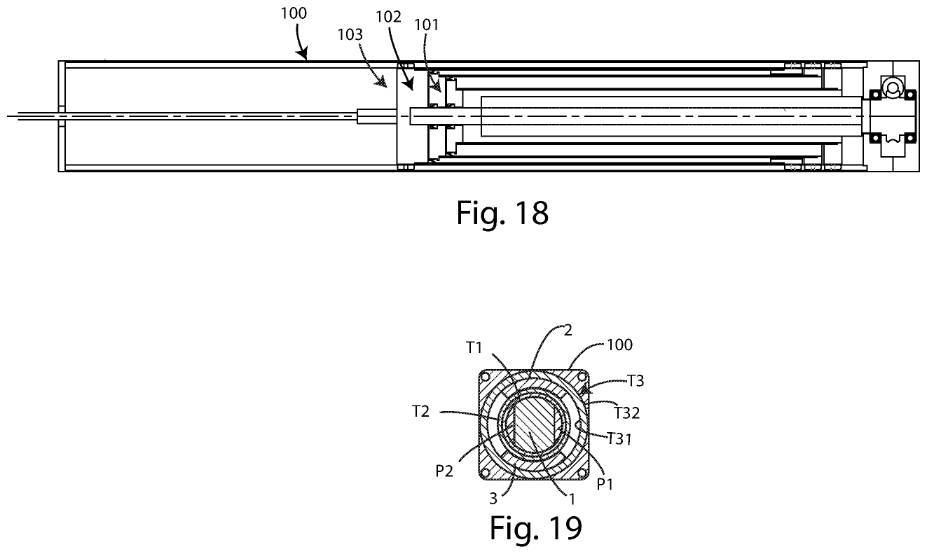

FIG. 18 is a schematic view of a second embodiment of the system, comprising a casing inside which a first unit, a second unit sliding on said first unit, and a third unit sliding on said second unit, are arranged;

FIG. 19 is a cross section of the system of FIG. 18.

With reference to FIGS. 1-12C, a system for generating a force, in particular a driving force, is disclosed.

As already said, the system is connectable to a fitness machine and the force generated by said system is the resistance that the user of the fitness machine must win during an exercise.

In particular, said system comprises:
a casing 100 having a cavity 10, where said cavity comprises a surface 100A,
a first unit 101, arranged inside the cavity 10 of said casing 100 and comprising:
   a first tubular element T1 having a longitudinal axis L and comprising a first surface or inner surface T11 and a second surface or outer surface T12 (opposite to said first surface T11),
   first magnetic means comprising at least one first magnetic element 1, wherein said at least one first magnetic element 1 comprises:
   a first face 11 and a second face 12, opposite to said first face 11, each of which has a respective first portion 111, 121 polarized with a first polarity (North polarity in the example being described) and a second portion 112, 122 polarized with a second polarity (South polarity in the example being described), opposite to said first polarity,
   a third face 13 connecting the first portion of said first face 11 to the first portion of the second face 12 and is polarized with said first polarity (i.e. North polarity), and
   a fourth face 14 connecting the second portion of said first face 11 to the second portion of the second face 12 and polarized with said second polarity (i.e. South polarity), wherein said at least one first magnetic element 1 is arranged inside said first tubular element T1 in such a way that a first axis A1, coinciding with said longitudinal axis L, is perpendicular to said first face 11 and to said second face 12 and that third face 13 and fourth face 14 contact a respective portion of inner surface T11 of said first tubular element T1,
a second unit 102, arranged inside the cavity 10 of said casing 100, sliding on said first unit 101 and comprising:
   a second tubular element T2, where said second tubular element T2 is coaxial with said first tubular element T1 and comprises a first surface or inner surface T21, and a second surface or outer surface T22 (opposite to said first surface T21),
   second magnetic means comprising at least one second magnetic element 2, wherein said at least one second magnetic element 2 comprises:
      a first face 21 and a second face 22, opposite to said first face 21, each of which has a respective first portion 211, 221, polarized with a first polarity (North polarity in the example being described) and a respective second portion 212,222 polarized with a second polarity (South polarity in the example being described), opposite to said first polarity,
      a third face 23, arranged between said first face 21 and said second face 22, and polarized with said second polarity (i.e. South polarity),
      where said at least one second magnetic element 2 is arranged on said second tubular element T2 in such a way that the third face 23 contacts a portion of the outer surface T22 of said second tubular element T2,
   third magnetic means comprising at least one third magnetic element 3, where said at least one third magnetic element 3 comprises:
      a first face 31 and a second face 32, opposite to said first face 31, each of which has a respective first portion 311, 321 polarized with a first polarity (North polarity in the example being described) and a second portion 312, 322 polarized with a second polarity (South polarity in the example being described), opposite to said first polarity,
      a third face 33, arranged between said first face 31 and said second face 32 and polarized with said first polarity (i.e. North polarity),
      where said at least one third magnetic element 3 is arranged on said second tubular element T2 in such a way that the second face 33 contacts a further portion of the outer surface T22 of said second tubular element T2, opposite to said portion.

With particular reference to the first unit 101, said first tubular element T1 is arranged inside said second tubular element T2.

In the embodiment being disclosed, the outer surface T12 of the first tubular element T1 contacts the inner surface T21 of the second tubular element T2.

However, it is not necessary that the outer surface T12 of the first tubular element T1 and the inner surface T21 of the second tubular element T2 are in contact each other.

The outer surface T12 of the first tubular element T1 can be at a predetermined first reference distance with respect to the inner surface T21 of the second tubular element T2, without thereby departing from the scope of the invention.

Furthermore, in the embodiment being disclosed, said first magnetic means 1 comprise a first plurality of first magnetic elements 1, said second magnetic means 2 comprise a second plurality of second magnetic elements 2, and said third magnetic means 3 comprise a third plurality of said third magnetic elements 3.

With reference to said first magnetic means, said first magnetic elements 1 are in contact each other and arranged in succession inside said first tubular element T1 along said first axis A1 in such a way that the second face 12 of a first magnetic element 1 is in contact with the first face 11 of the first magnetic element 1 arranged in succession.

With reference to said second magnetic means, said second magnetic elements 2 are arranged in succession along a portion of said second surface T22 of said second tubular element T2 in such a way that the second face 22 of a second magnetic element 2 contacts the first face 21 of the second magnetic element 2 arranged in succession and that the third face 23 of each second magnetic element 2 contacts the outer surface T22 of said second tubular element T2.

With reference to said third magnetic means, said third magnetic elements 3 are arranged in succession along a further portion of said second surface T22 of said second tubular element T2, opposite to said portion, in such a way that the second face 32 of each third magnetic element 3 contacts the first face of the third magnetic element 3 arranged in succession and that the third face 33 of each third magnetic element 3 contacts the outer surface T22 of said second tubular element T2.

In particular, the mass of said first magnetic elements 1, the mass of said second magnetic elements 2 and the mass of said third magnetic elements 3 are dimensioned in such a way that the system generates (by said first magnetic elements, said second magnetic elements and said third magnetic elements) a predetermined first force.

For example, in the embodiment being described, the masses of said first magnetic elements 1, of said second magnetic elements 2 and of said third magnetic elements 3 are dimensioned in order to said system generates a predetermined first force, the value of which is between 0 and 1000 Newton.

However, as explained later, said system is capable of generating a predetermined second force, by moving said second unit 102 with respect to said first unit 101 inside the cavity 10 of said casing 100.

Said predetermined second force can have a maximum value, when in the space between the outer surface T12 of the first tubular element T1 and the surface 100A of the cavity 10 there is no amount of air, or it may have a value between 0 and said maximum value, when an amount of air is present in said space.

In the absence of air inside said space, the value of said predetermined second force is maximum and depends on the dimensions of the cross section of the cavity 10.

In the presence of an amount of air inside said space, the value of said predetermined second force depends on the dimensions of the cross section of the cavity 10 and/or the distance traveled by second unit 102 during sliding with respect to said first unit 101.

Consequently, said system is capable of generating a resulting force given by the sum of said predetermined first force and of said predetermined second force.

Moreover, said first unit 101 comprises positioning means for positioning said first magnetic elements 1 along said first axis A1.

Said positioning means are arranged inside said first tubular element T1.

In the embodiment being disclosed, said first positioning means comprise a first positioning element P1 and a second positioning element P2 for each first magnetic element 1.

Each first positioning element P1 is arranged in contact with a fifth face 15 of said first magnetic element 1 and with the inner surface T11 of said first tubular element T1, and each second positioning element P2 is arranged in contact with a sixth face 16 of said first magnetic element 1, opposite to said fifth face 15, and with the inner surface T11 of said first tubular element T1.

However, although not shown, said positioning means can comprise a first positioning element P1, whose length is such that said first positioning element P1 contacts each fifth face 15 of said first magnetic elements 1, and a second positioning element P2, whose length is such that said second positioning element P2 contacts each sixth face 16 of said first magnetic elements 1, without thereby departing from the scope of the invention.

With particular reference to said first tubular element T1, said first tubular element T1 is configured to rotate about its longitudinal axis L of a predetermined rotation angle α in a first direction or in a second direction, opposite to said first direction, in such a way that, when said first tubular element T1 rotates, said first magnetic elements 1 rotate with respect to said second magnetic elements 2 and to said third magnetic elements 3.

As explained later (with reference to FIGS. 13A, 13B, 13C), the value of said predetermined first force depends on said predetermined rotation angle and on the polarities of said first magnetic elements 1 with respect to the polarities of said second magnetic elements 2 and to the polarities of said third magnetic elements 3.

In the embodiment being described, said first unit 101 comprises rotation means for rotating said first tubular element T1 (with respect to said second tubular element T2) about its longitudinal axis L, of said predetermined rotation angle, preferably included between 0° and 90°.

In particular, said rotation means comprise:
a worm screw 17,
a gear wheel 18, geared with said worm screw 17 in such a way that, when said worm screw 17 rotates, said gear wheel 18 rotates,
a shaft 19, coupled to said geared wheel 18 and said first tubular element T1 in such a way that, when said gear wheel 18 rotates, said shaft 19 rotates causing the rotation of said first element tubular T1.

By means of the worm screw 17, a user can decide the rotation angle of said first tubular element T1.

Through a load cell (not shown in the Figures) connected to MC connecting means (for example a metal cable) for connecting the second unit 102 of said system to the fitness machine, and displaying means (not shown) for displaying one or more data, connected to said load cell, a user can verify the weight expressed in a predetermined unit of measurement of known type (for example Kg) which can be obtained through said system.

Consequently, the second unit 102 is connectable to the fitness machine (in particular to the actuator of the fitness machine, such as a handlebar) through said connection means MC. Moreover, the casing 100 can be connected to the fitness machine by means coupling means of known type.

In particular, in the embodiment being described, said first unit 101 comprises a box-like body or container C, arranged at a first end of said first tubular element T1, and at least one first part of said worm screw 17, said gear wheel 18 and said shaft 19 are arranged inside said container C.

A second part of said worm screw 17 is external to said container C, so that said worm screw 17 can be rotated.

In the embodiment being described, said container C comprises a first part C1 and a second part C2, coupable to said first part C1. In particular, said second part C2 is coupable to said first part C1 by means of a plurality of first screws V.

Said container C comprises a hole F to allow passage of a first end portion of said first tubular element T1 in such a way that said first end portion is connected to said shaft 19.

A first bearing B1 is keyed on the gear wheel 18 and a second bearing B2 is arranged between the shaft 19 and the gear wheel 18.

A first sealing gasket G1, arranged between said hole F and said first end portion of said first tubular element T1, prevents the passage of air inside the casing 100 (i.e. in the space between the outer surface T12 of the first tubular element T1 and the surface 100A of the cavity 10 of said casing 100).

Moreover, said first unit 101 comprises damping means DM for damping a possible impact of said second unit 102 with said container C, where said damping means are arranged in contact with said first part C1 of said container C.

Said first unit 101 comprises a cap T, arranged at a second end of said first tubular element T1, opposite said first end, provided with first sliding means R1 for facilitating the sliding of said second unit 102 on said first unit 101.

In the embodiment being disclosed, said first sliding means R1 comprise a plurality of first wheels.

With particular reference to said second unit, said second unit 102 comprises:
coupling means made of ferromagnetic material for coupling said second magnetic means 2 and said third magnetic means 3 with said outer surface T22 of said second tubular element T2,
blocking means for blocking said coupling means.

In the example being disclosed, said coupling means comprise a plurality of sheets 423, arranged in succession in such a way that said sheets 423 are overlapped on said second magnetic elements 2 and said third magnetic elements 3.

Each sheet 423 has a first hole 423A shaped to allow the passage of said second tubular element T2 on which said second magnetic elements 2 and said third magnetic elements 3 are arranged, as well as a second hole 423B and a third hole 423C.

Furthermore, said blocking means comprise a first blocking element 24 and a second blocking element 25, each of which passes through a respective second hole 423B and third hole 423C for blocking said sheets 423.

Furthermore, the second unit 102 comprises guiding means to allow said second unit 102 to slide with respect to said casing 100, where said guiding means comprise at least one first guiding element, and said cavity 10 is provided with at least one first protrusion (not shown in Figures), on which said at least one first guiding means slides.

In the embodiment being disclosed, said guiding means comprise a first guiding element 26 and a second guiding element 27 and said cavity 10 is provided with a first protrusion, on which said first guiding element 26 slides, and a second protrusion, on which said second guiding element 27 slides, where said first protrusion is arranged on a first surface portion of the surface 100A of said cavity 10 and said second protrusion is arranged on a second surface portion, opposite said first surface portion.

In particular, said first guiding element contacts a first portion of said coupling means and said second guiding element contacts a second portion of said coupling means, opposite to said first portion.

Furthermore, each guiding element has a C-shaped shape.

A further function of said guiding elements 26, 27 and said protrusions is to prevent said second tubular element T2 from accidentally rotating during the rotation of said first tubular element T1.

According to the invention, said second unit comprises a first head 21, arranged at a first end of said second tubular element T2, and a second head 22, arranged at a second end of said second tubular element T2, opposite to said first end.

Said first head 21 comprises inside a piston 28, as well as a second sealing gasket G2 and a third sealing gasket G3.

In the embodiment being disclosed, said piston 28 is integral with said first head 21, since it is coupled with said head 21 by means of a plurality of second screws V2.

Furthermore, said piston 28 has a circular crown-shaped cross section.

Said second sealing gasket G2 and said third sealing gasket G3 contact respectively the inner circumference and the outer circumference of said circular crown.

As known, the inner circumference has a diameter smaller than the diameter of the outer circumference. Consequently, the sealing gaskets G2, G3 are sized according to the diameter of the circumference on which they are applied.

Each sealing gasket G2, G3 prevent the passage of air inside the casing, in the space between the outer surface of the first tubular element T1 and the surface 100A of the cavity 10 of said casing 100.

Said first head is provided with second sliding means R2 for facilitating the sliding of said second unit 102 on said first unit 101.

Similarly to said first head, also the second head 22 is provided with third sliding means R3 for facilitating the sliding of said second unit 102 with respect to said first unit 101.

In the embodiment being disclosed, said second sliding means R2 comprise a plurality of second wheels and said third sliding means R3 comprise a plurality of third wheels.

FIG. 13A is a schematic view showing the field lines of magnetic fields which are generated by said first magnetic elements 1, said second magnetic elements 2 and said third magnetic elements 3, when said first tubular element T1 is in a first position with respect to said second tubular element T2.

In this first position, a portion of a second magnetic element 2 and a portion of a third magnetic element 3, opposite to said second magnetic element, are arranged along a second axis A2, perpendicular to said first axis A1, and the first face 11 of said first magnetic elements 1 is arranged along a third axis A3 which coincides with said second axis A2.

In this first position, the predetermined first force generated by the system s maximum.

The third face 13 of the first magnetic element 1 is faced to the third face 23 of the second magnetic element 2 and the fourth face 14 of the first magnetic element is faced to the third face 33 of the third magnetic element 3.

The third face 13 of the first magnetic element 1 has a polarity opposite to the polarity of the third face 23 of the second magnetic element 2 and the fourth face 14 of the first magnetic element 1 has a polarity opposite to the polarity of the third face 33 of the third magnetic element 3.

FIG. 13B is a schematic view showing the field lines of magnetic fields which are generated by said first magnetic elements 1, said second magnetic elements 2 and said third magnetic elements 3, when said first tubular element T1 is in a second position with respect to said second tubular element T2.

As can be seen from FIG. 13B, said first tubular element T1 is rotated in a first direction with respect to said second tubular element T2 of a predetermined rotation angle α of 90°.

In other words, said third axis A3 forms an angle of 90° with said second axis A2.

In this second position, the predetermined first force generated by the system is minimal, substantially equal to 0.

Due to the rotation, the third face 13 of the first magnetic element 1 is no longer faced to the third face 23 of the second magnetic element 2 and the fourth face 14 of the first magnetic element 1 is no longer faced to the third face 33 of the third element magnetic 3.

As can be seen from the field lines shown in FIG. 13B, the magnetic fields generated by said first magnetic elements 1, said second magnetic elements 2 and said third magnetic elements 3 are substantially non-existent.

FIG. 13C is a schematic view showing the field lines of magnetic fields which are generated by said first magnetic elements 1, said second magnetic elements 2 and said third magnetic elements, when said first tubular element T1 is in a third position with respect to said second tubular element T2.

As can be seen from FIG. 13C, said first tubular element T1 is rotated in a first direction with respect to said second tubular element T2 of a predetermined rotation angle α of 45°.

In other words, said third axis A3 forms an angle of 45° with said second axis A2.

In this third position, the predetermined first force generated by the system has a value between the maximum value and the minimum value.

Due to the rotation, the third face 13 of the first magnetic element 1 is faced to a portion of the third face 23 of the second magnetic element 2 and the fourth face 14 of the first magnetic element is faced to a portion of the third face 33 of the third magnetic element 3.

Consequently, in the light of the polarities of the third face 13 and of the fourth face 14 of the first magnetic element 1 and of the polarities of the third face 23 of the second magnetic element 2 and of the third face 33 of the third magnetic element 3 a predetermined first force is generated.

As already said, said second unit 102 is sliding on said first unit 101.

According to the invention, in fact, said first tubular element T1 is arranged inside said second tubular element T2 and preferably said second unit 102 is slidably coupled to said first unit 101 in such a way as to slide with respect to said first unit 101, inside said casing 100, from a first position, where said second unit 102 is overlapped on said first unit 101 (FIG. 14), at a second position, where said second unit 102 is translated by a predetermined first distance with respect to said first unit 101 and is partially overlapped on said first unit 101 (FIG. 15), and vice versa.

As can be seen from FIG. 16, in said first position, the first head 21 of said second unit 102 is in contact with the container C of said first unit 101 (in particular with the first part C1 of said container C).

As can be seen in FIG. 17, in said second position, the first head 21 is translated inside the cavity 10 of the casing 100 of a predetermined first distance with respect to said first unit 101.

In said second position, there is a space S between the outer surface T12 of the first tubular element T1 and the surface 100A of the cavity 10 of said casing 100. This space S is due to the movement of said second unit 102 with respect to the first unit 101 at inside the cavity 10 of the casing 100.

In the absence of air in said space S, a predetermined second force is generated by said system. The maximum value of said predetermined second force depends on the dimensions of the cross-section of the cavity 10 of said casing 100.

In the embodiment being disclosed, the cross-section of said cavity 10 is dimensioned in order to said predetermined second force is equal to 1000 N.

In the presence of an amount of air in said space S, said predetermined second force has a value lower than the maximum value and depends on the dimensions of the cross section of said cavity and on said predetermined first distance.

Consequently, in the embodiment being described, the system can generate a resulting force (given by the sum of said predetermined first force and of said predetermined second force) which is maximum 2000N.

In other words, when said second unit 102 is in said first position, the resulting force generated by said system is said predetermined first force, and when the second unit 102 is in said second position, the resulting force generated by said system is the sum of said predetermined first force and of said predetermined second force.

As can be seen from FIGS. 16 and 17, said container C has an inlet CA for the passage of an amount of air from the external environment inside the casing 100 and opening/closing means CB for opening/closing said inlet to the to allow/prevent the passage of said amount of air through said inlet CA.

When said opening/closing means CB close said inlet CA, the passage of air inside the cavity 10 of the casing 100 is prevented.

If said inlet CA is closed before the second unit 102 is translated with respect to the first unit 101, a vacuum is created in the space S between the outer surface T12 of the first tubular element T1 and the surface 100A of the cavity 10 of the casing 100, since no amount of air is present.

Consequently, when said system is connected to an fitness machine and said fitness machine is in use, a user must win a resulting force given by the sum of a predetermined first force, which can have a value comprised between a minimum value and a maximum value (depending on the position of the first tubular element T1 with respect to the second tubular element T2) and a predetermined second force, which has a maximum value.

If said inlet CA is closed after the second unit 102 is translated with respect to the first unit 101, an amount of air is present in the space S between the outer surface T12 of the first tubular element T1 and the surface 100A of the cavity 10 of the casing 100.

Consequently, when said system is connected to an fitness machine and said fitness machine is in use, a user must win a resulting force given by the sum of a predetermined first force, which can have a value comprised between a minimum value and a maximum value (depending on the position of the first tubular element T1 with respect to the second tubular element T2) and a predetermined second force, which has a value comprised between a minimum value and a maximum value (depending on the dimensions of the cross section of said cavity 10 and/or how said second unit is translated with respect to said first unit).

In the example being described, said opening/closing means CB comprise a valve.

In FIGS. 18 and 19, a second embodiment of the system, object of the invention, is shown.

Differently from the first embodiment above disclosed, said system comprises a third unit 103 comprising a third tubular element T3 arranged inside the cavity 10 of said casing 100.

The second tubular element T2 of the second unit 102 is arranged inside said third tubular element T3.

Said third tubular element comprises a first surface or inner surface T31 and a second surface or outer surface T32, opposite to said first surface.

In the embodiment being disclosed, the inner surface T31 of said third tubular element T3 contacts said second magnetic elements 2 and said third magnetic elements 3.

However, the inner surface T13 of the third tubular element T3 can be at a predetermined second reference distance with respect to said second magnetic elements 2 and to said third magnetic elements 3, without thereby departing from the scope of the invention.

Said third unit 103 is slidably coupled to said second unit 102 in such a way as to slide with respect to said second unit 102, inside said casing 100, from a first position, where said third unit 103 is overlapped on said second unit 102, at a second position, where said third unit 103 is translated by a predetermined second distance with respect to said second unit 102 and is partially overlapped on said second unit 102.

Thus, in the event that said third unit 103 is translated with respect to said second unit 102, a further space is present between the outer surface of the third tubular element T3 and the surface 100A of the cavity 10 of the casing 100.

In said second position, a predetermined third force is generated by said system and its value depends on the dimensions of the cross section of said cavity 10 of said casing 100 and from said predetermined second distance.

Consequently, if the second unit 102 is translated with respect to said first unit 101 and said third unit 103 is translated with respect to said second unit 102, the resulting force generated by said system is the sum of said predetermined first force, said predetermined second force and said predetermined third force.

Advantageously, by means of the system object of the invention, a force can be generated.

A further advantage is given by the fact that said system, when applied to a fitness machine, simulates the pack of weight of known type which is connected to the handlebar of said fitness machine to enable a user to perform an exercise.

The present invention has been described for illustrative, but not limitative purposes, according to its preferred embodiment, but it is to be understood that variations and/or modifications can be carried out by a skilled in the art, without departing from the scope thereof, as defined according to enclosed claims.

1. A system for generating a force, in particular a driving force, said system being connectable to a fitness machine and comprising:
a first unit comprising:
a first tubular element having a longitudinal axis (L)
first magnetic means comprising at least one first magnetic element,
a second unit comprising:
a second tubular element, where said second tubular element is coaxial with said first tubular element,
second magnetic means comprising at least one second magnetic element,
third magnetic means comprising at least one third magnetic element,
where
said at least one first magnetic element is arranged within said first tubular element,
said at least one second magnetic element and said at least one third magnetic element are arranged on said second tubular element so as to be opposed to each other,
said first tubular element is arranged within said second tubular element and is configured to rotate about its longitudinal axis (L) of a predetermined rotation angle (α) in a first direction or in a second direction, opposite to said first direction, in such a way that, when said first tubular element rotates, said at least one first magnetic element rotates with respect to said at least one second magnetic element and said at least one third magnetic element, so that a predetermined first force is generated by said system, the value of said predetermined first force depending on the masses of said at least one first magnetic element, of said at least one second magnetic element and of said at least one third magnetic element, on the polarity of said at least one first magnetic element with respect to the polarity of said at least one second magnet and said at least one third magnetic element and on said predetermined angle of rotation.

2. The system according to claim 1, characterized in that
said second tubular element comprises an inner surface and an outer surface,
in that
said at least one second magnetic element is arranged on a portion of the outer surface of said second tubular element, and
in that
said at least one third magnetic element is arranged on a further portion of the outer surface of said second tubular element, opposite to said portion.

3. The system according to claim 2, characterized in that
said first tubular element comprises an inner surface and an outer surface
in that
said system comprising a casing having a cavity said cavity comprising a surface,
in that
said first unit and said second unit are arranged within the cavity of said casing,
in that
said second unit being slidably coupled to said first unit so as to slide with respect to said first unit, within said casing, from a first position, in which said second unit is overlapped on said first unit, to a second position, in which said second unit is translated by a predetermined first distance with respect to said first unit and partially overlapped on said first unit, so that a space between the outer surface of the first tubular element and the surface of the cavity of said casing is created, and vice versa; in said first position, the resulting force generated by said system being said predetermined first force, in said second position, a predetermined second force being generated by said system, the value of which depends on the dimensions of the cross-section of said cavity of said casing and on said predetermined first distance, and the resulting force generated by said system being the sum of said predetermined first force and said predetermined second force.

4. The system according to claim 1, characterized in that:
said at least one first magnetic element comprises:
a first face and a second face, opposite to said first face, each of which has a respective first portion polarized with a first polarity and a second portion polarized with a second polarity, opposite to said first polarity,
a third face, where said third face connects the first portion of said first face to the first portion of the second face and is polarized with said first polarity, and
a fourth face, opposite to said third face, where said fourth face connects the second portion of said first face to the second portion of the second face and is polarized with said second polarity,
said at least one first magnetic element being arranged within said first tubular element in such a way that a first axis, coincident with said longitudinal axis (L), is perpendicular to said first face and said second face, and that said third face and said fourth face contact said inner surface of said first tubular element,
in that
said at least one second magnetic element comprises:
a first face and a second face, opposite to said first face, each of which has a respective first portion polarized with a first polarity and a respective second portion polarized with a second polarity, opposite to said first polarity,
a third face, arranged between said first face and said second face and polarized with said second polarity,
said at least one second magnetic element being arranged on said second tubular element in such a way that said third face contacts a portion of said outer surface of said second tubular element
in that
said at least one third magnetic element comprises:
a first face and a second face opposite to said first face, each of which has a respective first portion polarized with a first polarity, and a second portion polarized with a second polarity, opposite to said first polarity,
a third face arranged between said first face and said second face and polarized with said first polarity,
said at least one third magnetic element being arranged on said second tubular element in such a way that said third face contacts a further portion of said outer surface of said second tubular element, opposite to said portion.

5. The system according to claim 4, characterized in that
said first magnetic means comprise a first plurality of first magnetic elements, said first magnetic elements being in contact with each other and arranged in succession within said first tubular element along said first axis so that the second face of a first magnetic element is in contact with the first face of the first magnetic element arranged in succession,
in that
said second magnetic means comprise a second plurality of second magnetic elements arranged in succession along said portion of said outer surface of said second tubular element so that the second face of a second magnetic element contacts the first face of the second magnetic element arranged in succession and that the third face of each second magnetic element contacts said outer surface of said second tubular element,
in that
said third magnetic means comprise a third plurality of third magnetic elements arranged in succession along said further portion of said outer surface of said second tubular element, so that the second face of each third magnetic element contacts the first face of the third magnetic element arranged in succession and that the third face of each third magnetic element contacts said outer surface of said second element tubular.

6. The system according to claim 2, characterized in that said second unit comprises:
coupling means made of ferromagnetic material for coupling said second magnetic means and said third magnetic elements with said outer surface of said second tubular element; and
blocking means for blocking said coupling means.

7. The system according to claim 5, characterized in that
said coupling means comprise a plurality of sheets arranged in succession in such a way that said sheets are overlapped on said second magnetic elements and said third magnetic elements, each sheet having a first hole shaped to allow the passage of said second tubular element, said second magnetic means and said third magnetic means, as well as a second hole and a third hole, and
in that
said blocking means comprise a first blocking element and a second blocking element, said first blocking element and said second blocking element passing through respectively said second hole and said third hole.

8. The system according to claim 1, characterized in that said system comprises rotating means for rotating said first tubular element with respect to said second tubular element of said predetermined rotation angle (α).

9. The system according to claim 8, characterized in that said rotation means comprise
a worm screw,
a gear wheel, geared with said worm screw in such a way that, when said worm screw rotates, said gear wheel rotates,
a shaft, coupled to said geared wheel and said first tubular element in such a way that, when said gear wheel rotates, said shaft rotates causing the rotation of said first element tubular.

10. The system according to claim 1, characterized in that said system comprises a container arranged at a first end of said first tubular element, and in that said container has an inlet for the passage of an amount of air from the external environment inside the casing and includes opening/closing means for opening/closing said inlet in order to allow/prevent the passage of said amount of air inside said casing through said inlet.

11. The system according to claim 9, characterized in that at least one portion of said worm screw, said gear wheel and said shaft are arranged inside said container and in that said container has a hole to allow the passage of a first end portion of said first tubular element in such a way that said first end portion is connected to said shaft; a first sealing gasket being arranged between said hole and said first end portion of said first tubular element.

12. The system according to claim 10, characterized in that said system comprises a cap arranged at a second end of said first tubular element, opposite to said first end, where said cap is provided with first sliding means for facilitating the sliding of said second unit on said first unit.

13. The system according to claim 4, characterized in that said first unit comprises positioning means for positioning said at least one first magnetic element within said first tubular element along said first axis; said positioning means being arranged within said first tubular element.

14. The system according to claim 3, characterized in that said positioning means comprise at least one first positioning element arranged in contact with a fifth face of said at least one first magnetic element and with said inner surface of said first tubular element, and at least one second positioning element arranged in contact with a sixth face of said at least one first magnetic element, opposite to said fifth face, and with said inner surface of said first tubular element.

15. The system according to claim 1, characterized in that said second unit comprises:
a first head, arranged at a first end of said second tubular element, where said first head comprises inside a piston having a cross-section in the shape of a circular crown, where said piston is integral with said first head, a second sealing gasket and a third sealing gasket respectively in contact with the inner circumference and the outer circumference of said circular crown, and
a second head, arranged at a second end of said second tubular element, opposite to said first end;
where
said first head and said second head are provided respectively with second sliding means and third sliding means for facilitating the sliding of said second unit on said first unit.

16. The system according to claim 3, characterized in that said cavity is provided with at least one first projection, said second unit comprising guiding means to allow said second unit to slide with respect to said casing on said first projection; where said guiding means comprise at least one first guiding element.

17. The system according to claim 16, characterized in that said cavity is provided with a second projection, said first projection and said second projection being arranged on the surface of said cavity respectively at a first surface portion and a second surface portion, opposite to said first surface portion, and said guiding means comprise a second guiding element, where said first guiding element and said second guiding element slide respectively on said first projection and on said second projection.

18. The system according to claim 1, characterized in that said system comprises a third unit arranged within said cavity of said casing and said third unit being slidably coupled to said second unit in such a way to slide with respect to said first unit, within said casing from a first position, in which said third unit is overlapped on said second unit, to a second position, in which said third unit is translated by a predetermined second distance with respect to said second unit and is partially overlapped on said second unit, and vice versa.
